(19) United States
(12) Patent Application Publication
(10) Pub. No.: US 2001/0026372 A1
(43) Pub. Date: Oct. 4, 2001

(54) Image forming apparatus, control apparatus and density correcting method

(76) Inventor: Reiji Misawa, Tokyo (JP)

Correspondence Address: FITZPATRICK CELLA HARPER & SCINTO, 30 ROCKEFELLER PLAZA, NEW YORK, NY, 10112, US

(21) Appl. No.: 09/805,243

(22) Filed: Mar. 14, 2001

(30) Foreign Application Priority Data
Mar. 16, 2000 (JP) 2000-073678

(51) Int. Cl. B41J 1/00

(52) U.S. Cl. 358/1.9

(57) ABSTRACT

The invention provides an image forming apparatus, a control apparatus and a density correcting method, for reading plural gradient patterns, creating a correction table for correcting the density characteristics of the image data based on the read plural gradient patterns, correcting the read image with thus created correction table, and outputting the corrected image, wherein the plural gradient patterns for creating the correction table are disposed in point symmetry with respect to the center position of the image.

### BACKGROUND OF THE INVENTION

1. Field of the Invention

The present invention relates to an image forming apparatus, a control apparatus and a density correcting method capable of correcting a read image, and more particularly an image forming apparatus, a control apparatus and a density correcting method capable of reading plural gradient patterns, creating a correction table for correcting the density characteristics of image data based on the read plural gradient patterns, correcting a read image utilizing the created correction table and outputting the corrected image.

2. Related Background Art

In an image forming apparatus such as a multi function peripheral (hereinafter represented as MFP) having the functions of copying machine, printer and facsimile apparatus, the density characteriscis of the output image often becomes unstable depending on various factors such as the environment of use or the frequency of use.

For example, an image forming apparatus utilizing an electrophotographic process in an image outputting unit is often affected by the ambient temperature and humidity of the apparatus and the time-dependent change of the components in the steps of electrophotographic process such as the laser exposure, latent image formation on the photosensitive member, image development with toner, toner transfer to a paper medium and thermal fixation of the image. Therefore, the toner amount finally fixed on the paper fluctuates from time to time to result in a change in the density of the output image. Such instability in the density characteristics of the output image resulting from the environmental conditions (temperature, humidity) and the frequency use is not specific to the electrophotographic process but is also encountered in other image forming processes such as ink jet recording or thermal transfer recording.

For alleviating the instability in the density characteristics, there is conventionally known a method of creating a density correction table according to the change in the density characteristic of the output unit of the image forming apparatus and correcting the read image data with such density correction table. Such correction method will be briefly explained in the following with reference to FIGS. 14 and 15.

FIG. 14 represents the density characteristics in the output unit of the image forming apparatus, wherein the ordinate indicates the output density with “0” corresponding to while and “255” corresponding to solid black, while the abscissa indicates the input data value entered into the output unit of the image forming apparatus, with “0” corresponding to white and “255” corresponding to black. In FIG. 14, a broken line 1400 indicates ideal linear density characteristics, in which the printout denwsity becomes linear for linear input data.

However, the density characteristics of the output unit varies for example as indicated by 1401, 1402 or 1403 because of the influence of the environmental conditions or the frequency of use, and the input data are corrected by the density correction table in order to obtain linear output characteristics.

Now reference is made to FIG. 15 for explaining the density correction table used for correcting the linearity, wherein the ordinate indicates the input data (density data prior to density correction) while the abscissa indicates the output data (density data after density correction). A characteristic curve 1501 is used for correcting the characteristics of the characteristic curve 1401, and the curves 1401 and 1501 are mutually symmetrical with respect to the broken-lined linear characteristics. Similarly, a characteristic curve 1502 is used for correctingt the characteristics of the characteristic curve 1402, and that 1503 is used for correcting the characteristics of the curve 1403. The density correction tables contain the values of these characteristics curves 1501, 1502, 1503 in the form of tables, and the use of such density correction tables allows to correct the linearity of the output density.

The density characteristics of the output unit of the image forming apparatus, as indicated in FIG. 14, can be determined by a method utilizing a test output image as disclosed in the Japanese Patent Applications Laid-open Nos. 11-75067, 2000-59643 and 2000-69307. Such method will be explained in the following with an example shown in FIG. 16.

At first the image forming apparatus outputs a print sheet on which printed is a test output image consisting of a density gradient pattern. This test output image is generally a gradient pattern consisting of plural density patches (toner patches). As an example of the test output image, FIG. 16 shows a gradient pattern 1601 consisting of N density patches, printed on a print sheet 1600. A density patch 1602 represents the maximum density level, then the density becomes lower in succession in density patches 1603, 1604, . . . and reaches the minimum density level in an N-th density patch 1605. By reading the test output imae consisting of the density patches of N gradation levels with an original reading unit provided in the image forming apparatus, there can be obtained brightness data corresponding to such N gradation levels.

Then thus obtained brightness data are converted by lujminance-density conversion (logarithmic conversion) into density data, and thus obtained density data represent the density characteristics of the output unit which has outputted the print sheet 1600. The density correction table is to be so created that such density characteristics become linear.

However, in the creation of the density correction table, there are encountered the following drawbacks depending on the arrangement of the gradient pattern of the test output image printed on the print sheet 1600.

For example if the density is different between the both ends of a sheet, more specifically if it is darker at a side (A) shown in FIG. 16 than at the other side (B) and if the gradient pattern is printed in a position closer to the side (A), there will be created a gradation correction table matching the density of the side (A), so that the density will become lower at the side (B). Also even in case the gradient pattern is printed at the center of the sheet, the density after printing will not become uniform if there is a difference in density between the center of the sheet and the both sides thereof. As explained in the foregoing, a positional deviation in the arrangement of the gradient pattern inhibits obtaining the inherent density characteristics of the output unit, whereby an appropriate density correction table cannot be created.

Also in case the printing sheet 1600 is read in a direction opposite to the original reading direction 1606 shown in FIG. 16, the direction of the test output image becomes inverted so that an appropriate density correction table cannot be created also in such case.

Also in case there is employed a stepwise pattern as exemplified by the gradient pattern 1601 shown in FIG. 16, the adequate information for creating the correction table may not be obtained from such gradient pattern because of a deterioration in the image reading sensor or a printing error in the gradient pattern.

### SUMMARY OF THE INVENTION

In consideration of the foregoing, an object of the present invention is to provide an image forming apparatus, a control method therefor and a density correcting method capable of creating a density correction table taking into consideration a difference in density resulting from the difference in the image output position of the image forming apparatus, and creating a same correction tablea regardless of the reading direction of the image including a gradient pattern.

The above-mentioned object can be attained, according to an embodiment of the present invention, by an image forming apparatus for outputting an image based on inputted image data, comprising:

reading means for reading an image and generating image data;

creation means for creating a correction table for correcting the density characteristics of the image data;

correction means for correcting the density characteristics of the image data from the reading means, based on the correction table created by the creation means; and

output means for outputting an image based on the image data corrected by the correction means;

wherein the creation means creates the correction table based on data generated by tghe reading means by reading plural gradient patterns outputted by the output means, and the plural gradient patterns outputted by the output means are disposed in point symmetry with respect to a center position of the image.

Another object of the present invention is to provide an image forming apparatus, a control apparatus and a density correcting method capable of selecting a density correction table taking into consideration a difference in the image output position of the image forming apparatus, and selecting a same correction table regardless of the reading direction of the image including a gradient pattern.

The above-mentioned object can be attained, according to an embodiment of the present invention, by an image forming apparatus for outputting an image based on inputted image data, comprising:

reading means for reading an image and generating image data;

memory means for storing plural correction tables for correcting the density characteristics of image data;

selection means for selecting a correction table suitable for correction from the memory means;

correction means for correcting the density characteristics of the image data from the reading means, based on the correction table selected by the selection means; and

output means for outputting an image based on the image data corrected by the correction means;

wherein the selection means selects the correction table based on data generated by the reading means by reading plural gradient patterns outputted by the output means, and the plural gradient patterns outputted by the output means are disposed in point symmetry with respect to a center position of the image.

Still another object of the present invention is to provide a density correcting method capable of selecting a density cirrection table taking into consideration a difference in the density depending on the image output position of the image forming apparatus on the printing sheet, and selecting a same correction table regardless of the reading direction of the printing sheet bearing a gradient pattern.

The above-mentioned object can be attained, according to an embodiment of the present invention, by a density correcting method for use in an image forming apparatus, utilizing a print paper on which a test image is printed, the method comprising:

a printing step of printing a test image on a print paper; and

a detection step of detecting the condition of the image forming apparatus from the test image printed on the print paper;

wherein the print paper on which the test image is printed by the printing step is the print paper for detecting the condition of the image forming apparatus in the detection step, and the test image printed on the print paper is composed of plural gradient patterns which are disposed in point symmetry with respect to a center position of the print paper.

Still other objects of the present invention, and the features thereof, will become fully apparent from the following detailed description to be taken in conjunction with the accompanying drawings.

### BRIEF DESCRIPTION OF THE DRAWINGS

FIG. 1 is a block diagram showing the configuration of a multi function peripheral (MFP) embodying the present invention;

FIG. 2 is a block diagram showing the configuraiton of an image processing unit in the MFP embodying the presesnt invention;

FIG. 3 is a flow chart showing the process flow in an ordinary copying operation in an embodiment of the present invention;

FIG. 4 is a view showing the arrangement of gradient patterns in a test output image in a first embodiment;

FIG. 5 is a magnified view of the gradient pattern shown in FIG. 4;

FIG. 6 is a view showing a process flow for creating a density correction table in the first embodiment of the present invention;

FIG. 7 is a chart showing a characteristic curve obtained by an interpolation process on the values of the density correction table obtained from the test output image in the first embodiment;

FIG. 8 is a chart showing a characteristic curve obtained by a smoothing process on the characteristic curve shown in FIG. 7;

FIG. 9 is a view showing an example 1 of the program for smoothing process in the first embodiment;

FIG. 10 is a view showing an example 2 of the program for smoothing process in the first embodiment;

FIG. 11 is a view showing the arrangement of gradient patterns in a test output image in a second embodiment;

FIG. 12 is a chart showing an example of the characteristic curve of the correction table in the second embodiment;

FIG. 13 is a view showing the process flow for selecting the density correction table in the second embodiment;

FIG. 14 is a chart showing various output density characteristics in an image forming apparatus;

FIG. 15 is a chart showing characteristic curves for correcting the output density characteristics shown in FIG. 14; and

FIG. 16 is a view showing an example of a printed gradient pattern of a test output image, employed in setting the density correction table.

### DETAILED DESCRIPTION OF THE PREFERRED EMBODIMENTS

Now the present invention will be clarified in detail by preferred embodiments thereof, with reference to the accompanying drawings.

(First embodiment)

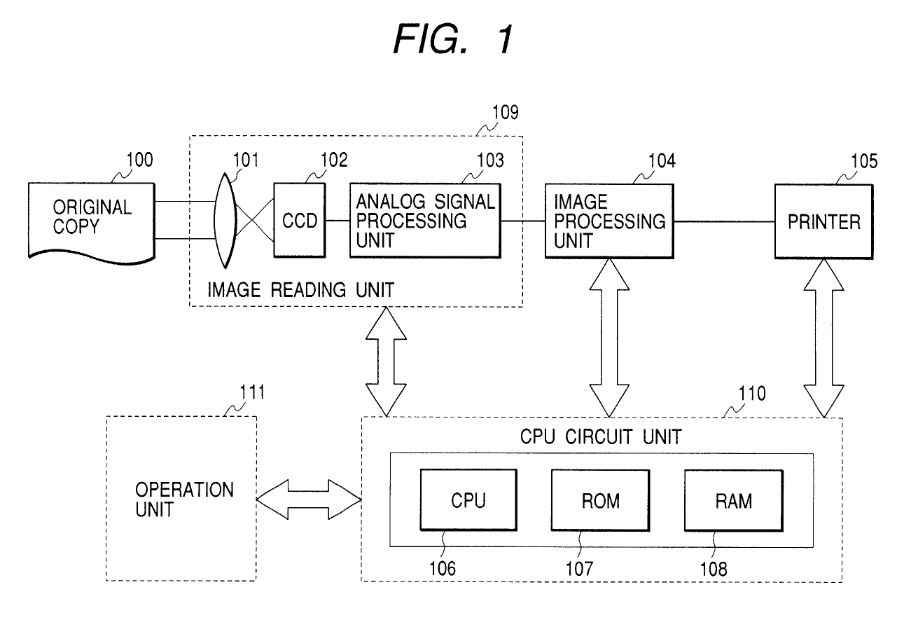

In the present embodiment, the present invention is applied to a digital composite apparatus or so-called multi function peripheral (MFP). FIG. 1 is a block diagram showing the configuration of the MFP in the present embodiment.

A manuscript or original 100 is a sheet-shaped print medium such as paper, bearing an image to be read by an image reading unit to be explained later. The original 100 can also be a print sheet on which printed is a test output image consisting of a gradient pattern to be explained later.

An image reading unit 109 reads the image of the original 100 and outputs the read image to an image processing unit to be explained later. The image reading unit 109 is provided therein with a lens 101 for condensing the light reflected from the original 100, a CCD sensor 102 for converting the light entered through the lens 101 into an electrical signal, an analog signal processing unit 103 for processing the output signal of the CCD sensor 102 etc.

In the following there will be briefly explained the function of the image reading unit 109 in response to an instruction for reading of the original image 100 from a CPU circuit to be explained later. At first the image data, focused on the CCD sensor 102 through the lens 101, are converted by the CCD sensor 102 into an analog electrical signal, and thus converted image data are entered into the analog signal processing unit 103. The image data entered into the analog signal proclessing unit 103 are subjected to sampling and holding for the dark level correction etc., then subjected to analog-digital (A/D) conversion and outputted as a digital image signal. The image data thus outputted are entered into an image processing unit 104.

The image processing unit 104 executes a correction process such as shading correction, required in a reading system, a smoothing process (not shown), an edge enhancement (not shown), a binary encoding process etc. After such various processing, the image data are outputted to aa printer unit 105.

The printer unit 105 is constituted by a printer apparatus such as a laser beam printer or an LED printer. For example, in case of a laser beam printer, the printer unit 105 is composed of an exposure control unit (not shown) provided with a semiconductor laser, an image forming unit (not shown), a conveying control unit for a transfer sheet etc. Based on the entered image data, the printer unit 105 records an image on a sheet-shaped print sheet.

A CPU circuit unit 110 controls the aforementioned image reading unit 109, the image processing unit 104, the printer unit 105, the operation unit 111 etc. and comprehensively controls the control sequence of the image forming apparatus of the present embodiment. The CPU circuit unit 110 is constituted by a CPU 106, a ROM 107, and a RAM 108. The CPU 106 executes various control programs. The ROM 107 stores the control programs to be executed by the CPU 106, data for the test output image and various data. The RAM 108 is used as a work area in the function of the CPU 106 and temporarily holds various data and values of the density correction tables. The CPU circuit unit 110 also executes creation of the density correction table to be explained later.

A manipulation unit or operation unit 111 is provided with various keyus for executing various settings and operations, and an LCD display unit (not shown), constituting a touch panel enabling an operation input in response to the depression of a button. The operation unit 111 also has functions of displaying various infrmation on the touch panel and controlling the operations by the user. The information set by the user through the operation unit 111 is supplied, through the CPU circuit unit 110, to the image reading unit 109, image processing unit 104, printer 105 etc.

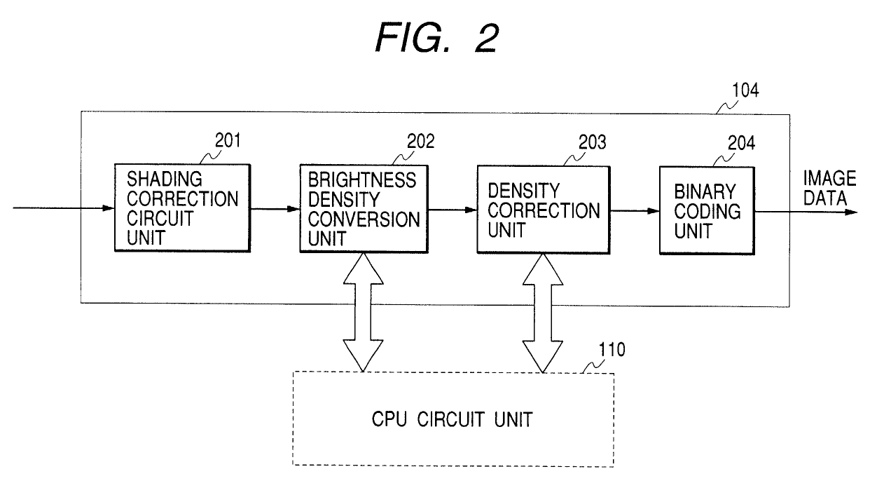

In the following there will be explained the details of the image processing unit 104 with reference to a block diagram shown in FIG. 2.

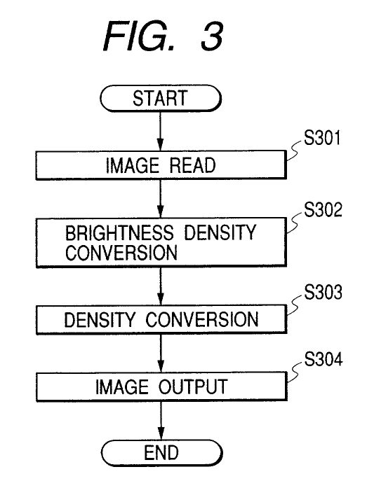

The image data entered from the analog signal processing unit 103 shown in FIG. 3 are entered into a shading correction unit 201, which executes correction for the fluctuation of the original reading sensor, and for the light distribution characteristics of an original illuminating lamp, and the corrected image data are entered into a brightness-density conversion unit 202.

The brightness-density conversion ujnit 202 applies logarithmic conversion on the input image data thereby executing conversion from the brightness data into density data. Usually, the brightness-density conversion is executed by a log table created according to the following equation (1), representing a case where the input and the output are both 8-bit signals:

Out=−255/Dmax * log (In/255) (1)

wherein In indicates brightness data, Out indicates density data and Dmax indicates maximum density.

The maximum density Dmax is a value determined from the result of measurement of the test output image.

The equation (1) converts the brightness data In so as to obtain a density Out=255 in case the original density is Dmax (representing a value), and means that the Out is limited to 255 in case Out exceeds 255. Thus, by varying Dmax according to the result of reading of the test output image, there can be alleviated the saturation of the density value at the end of the density data after the logarithmic conversion, thereby enabling to create a more appropriate density correction table. The conversion to the density is not limited to the foregoing equation (1) but may also be executed by other conversion formulae.

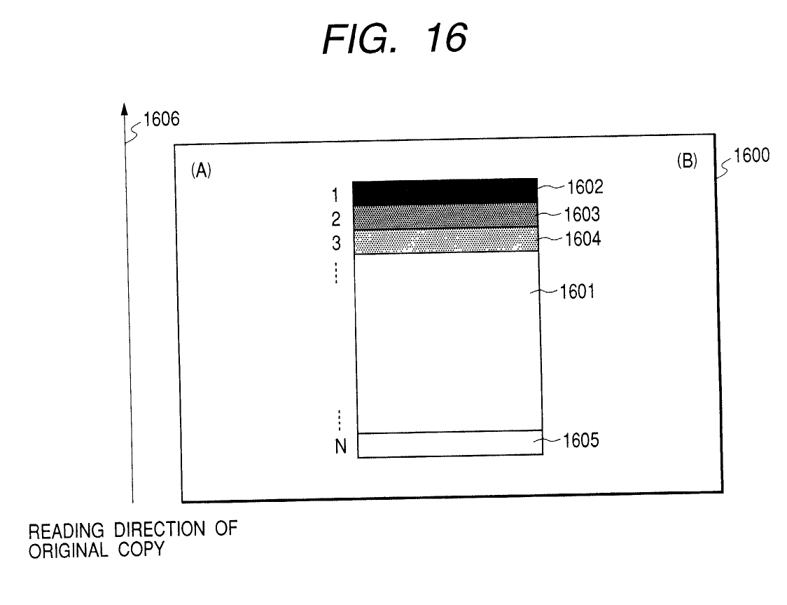

After the brightness-density conversion, the image data are entered into a density correction unit 203 which executes correction of the density characteristics of the density data after the brightness-density conversion. The correction unit is constructed as a table composed of a memory with 8-bit input and 8-bit output. More specifically, the table stores values corresponding to the curve 1501, 1502 or 1503 shown in FIG. 15. Through operations on the operation unit 111 to be explained later, the CPU circuit unit 110 sets a density correction table in the density correction unit 203. The image data after correction are binary encoded in a binary encoding unit 204 and outputted from the image processing unit 104 to the printer 105.

In the following there will be explained, with reference to a flow chart shown in FIG. 3, the process flow in an ordinary copying operation in the present embodiment.

At first the image reading unit 109 reads the image of the original 110, thereby creating brightness data (S301). Then the brightness data are subjected to a series of processings such as shading correction in the image processing unit 104, and then converted, in the brightness-density conversion unit 202, from the brightness data into density data according to the equation (1) (S302). The converted density data are subjected, in the density correction unit 203, to density correction by a density correction table (S303). The values of the density correction table are obtained from the density characteristics of the test output image to be explained later. The corrected density data are binary encoded and supplied to the printer unit 105, which, based on the entered image data, prints an image on the print sheet (S304).

In the following there will be explained the test output image used for creating the correction table and featuring the present invention.

At first there will be briefly explained the arrangement of the gradient pattern in the conventional test output image. FIG. 16 shows an example of the print sheet 1600 on which printed is a test output image constituted by a gradient pattern 1601 consisting of N density patches. As shown in FIG. 16, the test output image is usually composed of a gradient pattern of plural toner patches. A patch 1602 indicates a gradation level of maximum density, and the density becomes lower in the patches 1603, 1604, . . . , and reaches the minimum density in an N-th patch 1605. By reading the test output image having N gradation patches from the sheet 16001, there can be obtained brightness data corresponding to the N gradation levels.

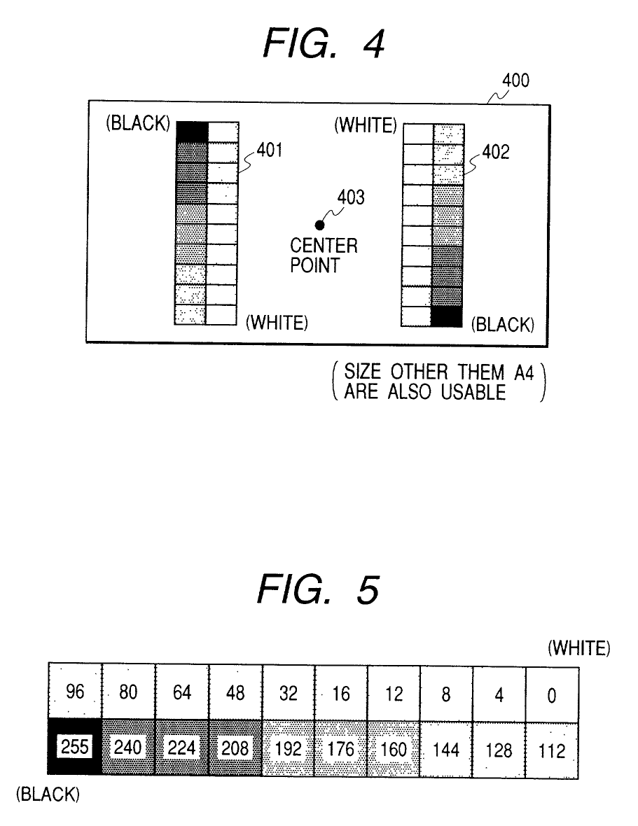

In the following there will be explained, with reference to FIGS. 4 and 5, the arrangement of the gradient pattern in the test output image of the present embodiment. As shown in FIG. 4, there are printed, on a sheet 400, two same gradient patterns 401, 402. The patterns 401, 402 are positioned in point symmetry with respect to a center point 403 of the sheet.

FIG. 5 is a magnified view of the gradient pattern shown in FIG. 4, with specific data (20 gradation levels) of the gradient pattern. In the present embodiment, the printer output data of the density patches are, in the order of increasing density, 0, 4, 8, 12, 16, 32, 48, 64, 80, 96, 112, 128, 144, 160, 176, 192, 208, 224, 240 and 255 as shown in FIG. 5.

In the present embodiment, there are employed 20 gradation levels, but the number of data in the gradient pattern is not limited to 20. The density characteristics of the printer unit can naturally be understood more exactly as the number of the gradation levels increases. Also the image forming method is not particularly limited, such as error diffusion method or dither method. Also the sheet for printing the test output image is assumed to be A4 size, but other sizes may also be employed.

Even if the operator sets the sheet 400 in an erroneous direction on the original table, the arrangement of the gradient patterns of the test output image as shown in FIGS. 4 and 5 allows to obtain a result same as in a correct sheet setting, since the test output image is point symmetrical with respect to the center point 403.

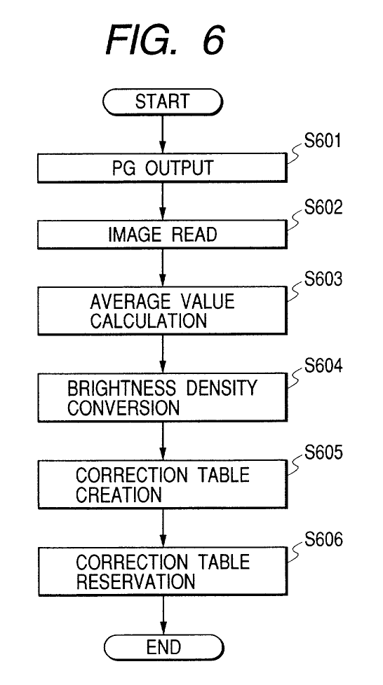

In the following there will be explained the flow of creation of the density correction table in the present embodiment, with reference to a flow chart shown in FIG. 6 and also to FIGS. 1 and 2.

At first a touch panel (not shown) of the operation unit 111 is used by the user for entering a command for outputting a sheet bearing a test output image. In response to the entered command, the CPU circuit unit 110 reads the gradient pattern data from the ROM 107 and causes the printer unit 105 to print the test output image consisting of the gradient pattern on the print sheet 400 (S601).

Then the outputted sheet 400 is set on the original table, and the user enters a reading command through the touch panel of the operation unit 110. In response, the CPU circuit unit 110 sends a reading instruction to the image reading unit 109, which in response reads the test output image printed on the sheet 400 (S602). The image data read by the image reading unit 109 are brightnesss data, generally proportional to the reflectance of the original.

The CPU circuit unit 110 determines the averages of the 20 sets of brightness data, corresponding to the density patches in the patterns 401, 402 constituting the test output image. Then the obtained averages of the brightness data of 20 sets are supplied to the image processing unit 104 (S603). The average of the brightness data is calculated according to the following equation (2):

PG_ average[N] =(PG401[N]+PG402[N])/2 (N=1 to 20) (2)

wherein PG_ average is the average brightness data while PG401 and PG402 are names of the left and right gradient patterns shown in FIG. 4, and PG401[N] and PG402[N] are read brightness data of each density patch of the gradient patterns, in which N indicates the number of the gradation level and the brightness data. In the present embodiment, there are employed 20 density patches which are numbered from 1 to 20 in the increasing order of density.

Then the brightness-density conversion unit 203 executes brightness-density conversion on the average brightness data of 20 sets, according to the logarithmic conversion equation (1) (S604).

The density data of 20 sets obtained by the brightness-density conversion are supplied to the CPU circuit unit 110, which executes interpolation and smoothing on the density data, thereby creating a density correction table including 256 data (S605).

The CPU circuit unit 110 stores the created correction table in the RAM 108 (S606).

The creation of the correction table in the present embodiment is thus terminated. In the ordinary copying operation, the created correction table is read from the RAM 108 and is set in the density correction unit 203. The process starting from the step S601 may be repeated if resetting of the correction table is desired.

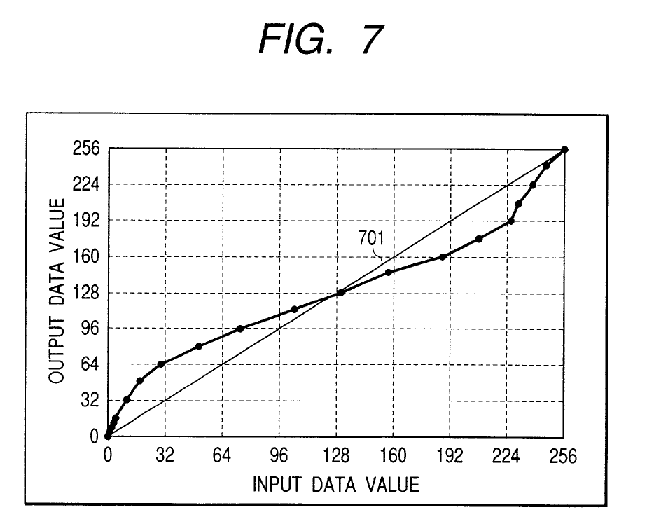

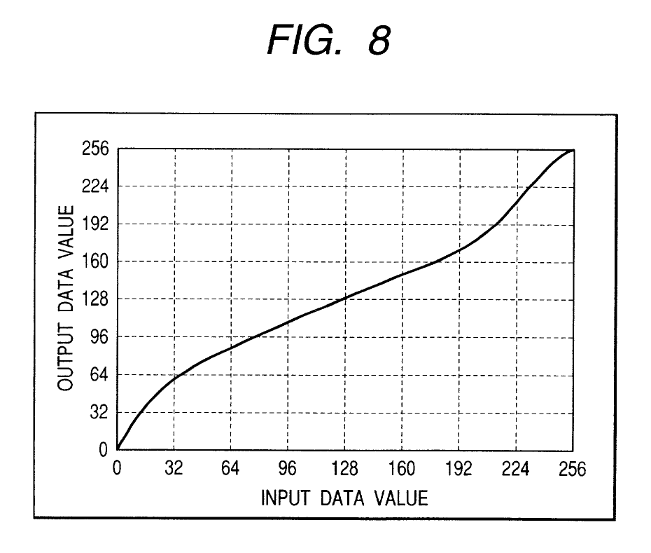

In the following there will be briefly explained the interpolation and smoothing in the step S605, with reference to FIGS. 7 and 8. The interpolation and smoothing may be executed also in the step S603, but, in the present embodiment, are executed solely on the density data in the step S605.

At first there will be explained the creation method of the density correction table in the present embodiment. The density data outputted from the brightness-density conversion unit 203 in the step S604 correspond to the input data to the printer unit 105 at the printing of the test output image on the sheet 400 in the step S601.

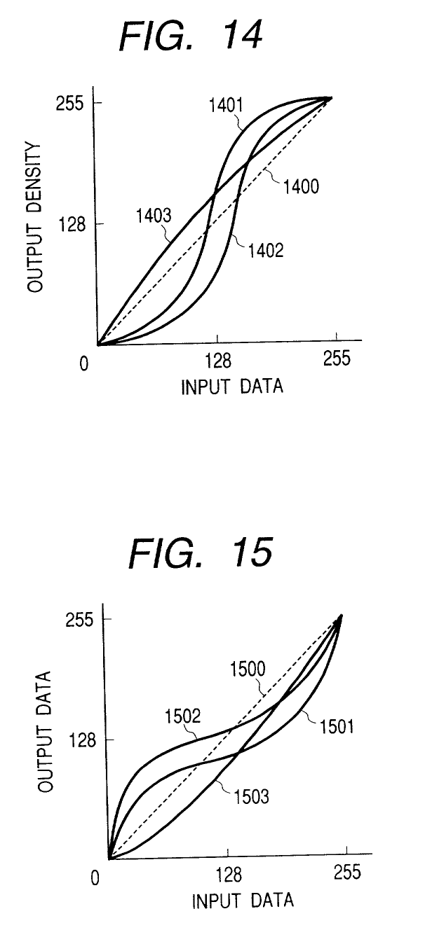

This relationship will be explained with reference to FIG. 14, in which the abscissa indicates the value of the input data while the ordinate indicates the value of the density data, namely the output density.

The relationship between the input data value and the output density represents the density characteristics of the printer unit 105. Therefore, the relationship between the output data value and the output density is ideally linear as represented by a line 1400. For example, the output density obtained by reading a density patch with an input data value of 32 should be 32, and that obtained by reading a density patch with an input data value of 64 should be 64.

However, the density characteristics of the printer unit 105 is often not linear, as represented by 1401, 1402 or 1403, because of the influence of the environmental conditions or of the frequency of use. For example, an input data value 32 supplied to the printer unit 105 may provide an output density of 25.

In the present embodiment, such characteristics are corrected by setting a density correction table shown in FIG. 15 in the density correction unit 203.

In FIG. 15, the abscissa indicates the input data to the density correction unit 203, and the ordinate indicates the output data from the density correction unit 203. A characteristic curve 1501 is to correct the characteristic curve 1401 and is symmetrical to the latter with respect to the linear characteristic curve indicated by a broken line. Similarly characteristic curves 1502, 1503 are to respectively correct the characteristic curves 1402, 1403. The density correction tables are composed of the values of these curves 1501, 1502, 1503, and allow to the linearity of the output density.

In the present embodiment, the correction table is created from the relationship between the density data obtained from the test output image and the straight line. More specifically, the density correction table is created by determining 20 data from the 20 density data obtained from the test output image so as to be symmetrical to the straight line, and obtaining 256 outputs by first-order interpolation.

In the following the interpolating process will be explained with reference to FIG. 7. in which the abscissa indicates the input density data to the density correction unit 203 and the ordinate indicates the output value from the density correction unit 203.

In FIG. 7, dots plotted on a curve indicate values so determined, for the density data of 20 sets obtained in the step S604, as to symmetrical with respect to a straight characteristic line 701.

In the present embodiment, the process is executed with 8 bits, and 256 data are required for constructing the density correction table of 8 bits. On the other hand, the number of the gradation levels in the test output image in the present embodiment and the number of density data obtained in the step S604 are 20. It is therefore required, in the step S605, to create a density correction table with 256 values from the brightness data of 20 sets.

In the present embodiment, first-order interpolation is executed on the 20 density data, thereby determining a characteristic curve with 256 values as shown in FIG. 7.

Such process alone allows to create a density correction table of a certain level, but such table may not be adequate for example because of an error in reading the brightness data of the test output image. Therefore, a smoothing process is applied to the characteristic curve obtained by interpolation to obtain a highly precise density correction table.

FIG. 8 shows a characteristic curve after smoothing, wherein the abscissa and the ordinate have the same meaning as in FIG. 7. Also there is executed an end correction process in an area where input data>160. The end correction process is to enable reproduction of the gradation in the high density area, sbut is omitted in the present embodiment.

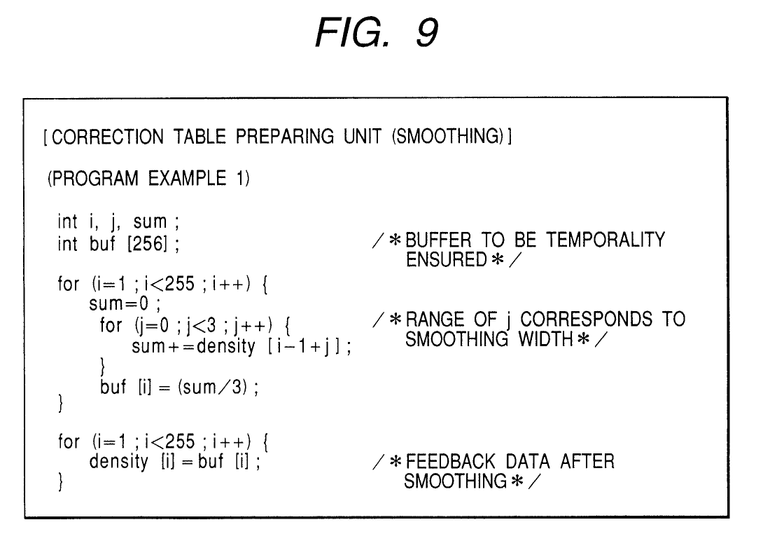

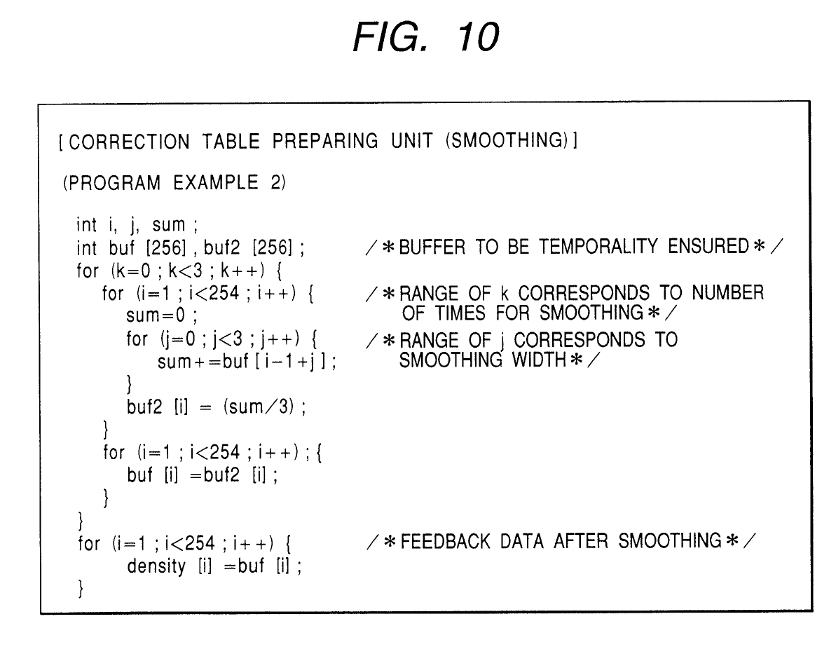

FIGS. 9 and 10 show examples of the smoothing program. In a program example 1 shown in FIG. 9, “density” indicates a train of 256 data, obtained by executing brightness-density conversion (logarithmic conversion) on the average brightness data “PG_ average” of the equation (2) and executingt first-order interpolation on the obtained 20 density data.

In this example, j indicates the range of smoothing, and, in the program example 1, there is executed a smoothing with a range of ±1 from i=2 to i=254.

Such example may be further modified for example by varying the smoothing range according to the value of i, or by repeating plural smoothing operations.

An example 2 shows a program of repeating three times a process of smoothing with a range ±1 from i=1 to i=254. The range and number of smoothing operation may be suitably selected according to the density characteristics of the printer.

The density correction table prepared as explained in the foregoing is stored in a memory device such as the RAM 108 of the CPU circuit unit 110.

The interpolating process and the smoothing process allow to create a high precise density correction table, even in case the created density correction taable is not appropriate for example by the influence of an error in reading the brightness data of the test output image.

In the present embodiment, as explained in the foregoing, the plural gradient patterns used for creating the correction table are disposed in point symmetry with respect to the center position of the output image, whereby the density correction table can be created in consideration of the density difference resulting from the difference in the output position of the image outputted by the image output apparatus, and also a same correction table can be created by reading the printed image including the gradient pattern in either direction.

(Second embodiment)

As a second embodiment, there will be explained a correcting method solely utilizing the maximum density level, in the arrangement of the gradient patterns in the test output image.

In the first embodiment, the density correction table is created utilizing a gradient pattern constituted by density patches of 20 gradation levels. Such method is highly effective if the image data can be accurately obtained from these patches.

However, if the error in reading the brightness data of the test output image grows larger for example by the deterioration of the reading sensor or by the error in printing the test output image, there cannot be obtained accutate information on the preset gradation levels, whereby the creation of the appropriate density correction table may become impossible.

Even in such situation, the density correction may be achieved relatively appropriately by a method of selecting and setting the density correction table based solely on the maximum density level.

In this method, there is read a test output image consisting of a patch of the maximum density level only, where the brightness data can be obtained most securely, and selecting an appropriate correction table from those stored in advance in the MFP based on the value of the obtained image data.

The selection of the correction table allows to dispense with the complex data processing such as interpolation, smoothing and end correction in the table creating process.

The present embodiment employs such density correction utilizing the maximum density level only. In the present embodiment, the configuration of the MFP is same as that in the first embodiment, and the process flow in the ordinary copying operation is same as illustrated in the flow chart shown in FIG. 3.

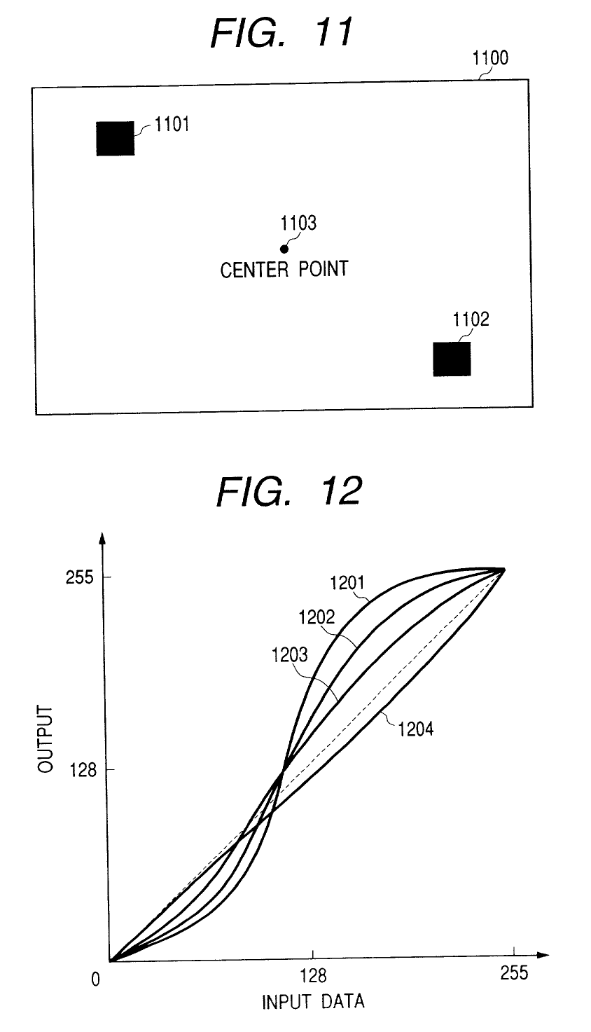

At first there will be explained, with reference to FIG. 11, the arrangement of the test output image featuring the present embodiment. On a paper sheet 1100, patches 1101, 1102 of the maximum density level are disposed in positions of point symmetry with respect to the center position 1103 of the sheet. The two patches are disposed in point symmetrical positions as shown in FIG. 11, as already explained in the first embodiment, in order to alleviate the deviation of the density information resulting from the difference in the output position of the output image and also to obtain a same correction table regardless of the reading direction of the image.

In the present embodiment, as there can only be obtained the information of the maximum density level, it is not possible to create the correction table from the obtained brightness data as in the first embodiment. Therefore, a selection is made among the density correction tables stored in advance in the image forming apparatus, based on the information obtained from the maximum density level. The selection of the optimum density correction table is made according to the value of the maximum density level Dmax of the test output image.

The values of the density correction table are stored in advance in the ROM 107. FIG. 12 shows examples of the characteristic curves of the density correction tables stored in the ROM 107.

In the present embodiment, there are stored density correction tables represented by four characteristics curves, and such density correction tables are selectively used in the following manner:

density correction table of curve 1201 if Dmax<1.4;

density correction table of curve 1201 if 1.4<Dmax<1.5;

density correction table of curve 1202 if 1.5<Dmax<1.6; and

density correction table of curve 1203 if 1.6<Dmax.

In the present embodiment, the specific values of the density correction tables will not be explained. The characteristic curves of the dehnsity correction tables stored in advance are preferably determined in optimum manner based on plural measurements made under different environmental conditions or at different time zones. Also, the present embodiment employs four density correction tables, but there may be employed any number of correction tables as long as appropriate density correction can be achieved.

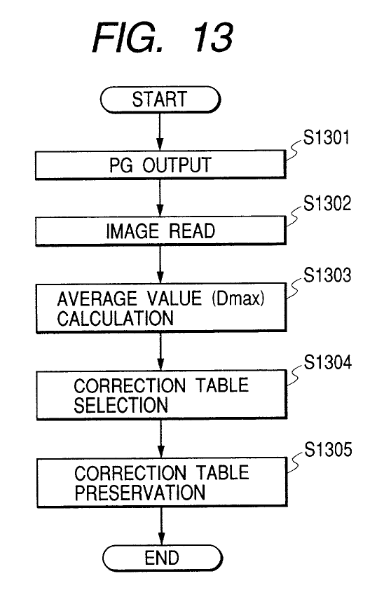

In the following there will be explained the process for selecting the density correction table in the present embodiment, with reference to a flow chart shown in FIG. 13.

At first, as in the first embodiment, the CPU circuit unit 110 controls, in response to an output command from the user, the printer unit 104 so as to output a sheet 1100 on which printed is a test output image consisting solely of the patches of the maximum density in the disposition shown in FIG. 11 (S1301). Then the outputted sheet 1100 is set on the image reading unit 109 for reading the test output image (S1302).

Then the CPU circuit unit 110 determines the average maximum density level Dmax from the brightness data obtained from the two patches of the maximum density (S1303).

The CPU circuit unit 110 selects and reads, from the ROM 107, a density correction table according to the obtained value of Dmax (S1304).

The read correction table is stored in the RAM 108 of the CPU circuit unit 110.

The selection of the correction table is thus completed. In executing the ordinary copying operation, the values of the correction table stored in the RAM 108 are set in the density correction unit 203, thereby executing density correction of the inputted image data.

In the present embodiment, there are disposed the patches of the maximum density level only, but it is also possible, in consideration of the simplification of the printing process and the user operation, to employ a disposition of the test output image same as in the first embodiment shown in FIGS. 4 and 5, and to read only the maximum density level in the gradient pattern.

In the present embodiment, as explained in the foregoing, the plural patches of the maximum density to be used for selecting the correction table are disposed in point symmetry with respect to the center position of the output image, thereby enabling simple and secure selection of the density correction table in consideration of the density difference resulting from the difference in the output position of the image outputted by the image output apparatus, and also enabling to select a same correction table regardless of the reading direction of the image including the gradient patterns.

The present invention has been explained by preferred embodiments, but the present invention is by no means limited by such embodiments and is subject to various modifications within the scope and spirit of the appended claims.

What is claimed is:

1. An image forming apparatus for outputting an image based on inputted image data, said apparatus comprising:
reading means for reading an image and generating image data;
creation means for creating a correction table for correcting the density characteristics of the image data;
correction means for correcting the density characteristics of the image data from said reading means, based on the correction table created by said creation means; and
output means for outputting an image based on the image data corrected by said correction means;
wherein said creation means creates the correction table based on data generated by said reading means by reading plural gradient patterns outputted by said output means, and the plural gradient patterns outputted by said output means are disposed in point symmetry with respect to a center position of the image.

2. The image forming apparatus according to claim 1, wherein said gradient pattern is composed of plural density patches.

3. The image forming apparatus according to claim 1, wherein said creation means determines a train of density data based on an average value of the plural brightness data obtained by said plural gradient patterns and applies an interpolating process and a smoothing process to said density data train thereby creating said correction table.

4. An image forming apparatus for outputting an image based on inputted image data, said apparatus comprising:
reading means for reading an image and generating image data;
memory means for storing plural correction tables for correcting the density characteristics of image data;
selection means for selecting a correction table suitable for correction from said memory means;
correction means for correcting the density characteristics of the image data from said reading means, based on the correction table selected by said selection means; and
output means for outputting an image based on the image data corrected by said correction means;
wherein said selection means selects the correction table based on data generated by said reading means by reading plural gradient patterns outputted by said output means, and the plural gradient patterns outputted by said output means are disposed in point symmetry with respect to a center position of the image.

5. The image forming apparatus according to claim 4, wherein said gradient pattern is solely composed of a patch of a maximum density.

6. The image forming apparatus according to claim 4, wherein said selection means selects said correction table according to a density value determined from the average of plural brightness data obtained by reading the maximum density patches of plural gradient patterns.

7. A control apparatus connected to an image forming apparatus capable of correcting image data generated by reading an image and outputting an image based on the corrected image data, and adapted for controlling the density correction by said image forming apparatus, the control apparatus comprising:
memory means for storing image data for outputting a test image;
output control means for controlling said image forming apparatus so as to output a test image based on the image data stored in said memory means;
reading control means for causing said image forming apparatus to read the test image outputted by said image forming apparatus, thereby generating image data;
creation means for creating a correction table for correcting the density characteristics of said image forming apparatus, based on image data obtained from the test image read by said image forming apparatus; and
setting means for setting the correction table created by said creation means, as the correction table to be used by said image forming apparatus;
wherein said memory means stores image data for outputting a test image in which plural gradient patterns are disposed in point symmetry with respect to the center position of the image.

8. A control apparatus connected to an image forming apparatus capable of correcting image data generated by reading an image and outputting an image based on the corrected image data, and adapted for controlling the density correction by said image forming apparatus, the control apparatus comprising:
first memory means for storing image data for outputting a test image;
second memory means for storing a correction table for correcting the density characteristics of said image forming apparatus;
output control means for controlling said image forming apparatus so as to output a test image based on the image data stored in said first memory means;
reading control means for causing said image forming apparatus to read the test image outputted by said image forming apparatus, thereby generating image data;
selection means for selecting, from said second memory means, a correction table suitable for correcting the density characteristics of said image forming apparatus, based on image data obtained from the test image read by said image forming apparatus; and
setting means for setting the correction table created by said creation means, as the correction table to be used by said image forming apparatus;
wherein said first memory means stores image data for outputting a test image in which plural gradient patterns are disposed in point symmetry with respect to the center position of the image.

9. A density correcting method for use in an image forming apparatus for correcting and outputting a read image, said method comprising:
a creation step of reading plural gradient patterns and creating a correction table for correcting the density characteristics of the image data based on the read plural gradient patterns;
a correction step of correcting the read image utilizing the correction table created by said creation step; and
an output step of outputting an image corrected by said correction step;
wherein the plural gradient patterns for creaating said correction table are disposed in point symmetry with respect to a center position of the image.

10. The density correcting method according to claim 9, wherein said gradient pattern is composed of plural density patches.

11. The density correcting method according to claim 9, wherein said generation step determines a train of density data based on the average of plural brightness data obtained by reading said plural gradient patterns and applies an interpolating process and a smoothing process on said density data train to create said correction table.

12. A density correcting method for use in an image forming apparatus for correcting and outputting a read image, said method comprising:
a selection step of reading plural gradient patterns and selecting a correction table for cirrecting the density characteristics of image data, based on said read plural gradient patterns;
a correction step of correcting the read image, utilizing the correction table selected by said selection step; and
an output step of outputting an image corrected by said correction step;
wherein the plural gradient patterns for selecting said correction table are disposed in point symmetry with respect to a center position of the image.

13. The density correcting method according to claim 12, wherein said gradient pattern is solely composed of a patch of a maximum density.

14. The density correcting method according to claim 12, wherein said selection step selects said correction table according to a density value determined from the average of plural brightness data obtained by reading the maximum density patches of plural gradient patterns.

15. A density correcting method utilizing a test chart and adapted for use in an image forming apparatus, said method comprising:
an output step of outputting a test chart; and
a detection step of detecting the condition of the image forming apparatus from said test chart;
wherein the test chart outputted by said output step is the test chart used by said detection step for detecting the condition of the image forming apparatus and is composed of plural gradient patterns which are disposed in a point symmetry with respect to a center position of the image.

16. A density correcting method for use in an image forming apparatus, utilizing a print paper on which a test image is printed, said method comprising:
a printing step of printing a test image on a print paper; and
a detection step of detecting the condition of the image forming apparatus from the test image printed on the print paper;
wherein the print paper on which the test image is printed by said printing step is the print paper for detecting the condition of the image forming apparatus in said detection step, and the test image printed on the print paper is composed of plural gradient patterns which are disposed in point symmetry with respect to a center position of the print paper.
